(19) United States
(12) Patent Application Publication
(10) Pub. No.: US 2004/0011162 A1
(43) Pub. Date: Jan. 22, 2004

(54) Ratchet mechanism for ratchet tools

(76) Inventor: Chih-Ching Hsien, Feng Yuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/195,489

(22) Filed: Jul. 16, 2002

(51) Int. Cl. B25B 13/46

(52) U.S. Cl. 81/63.2

(57) ABSTRACT

A ratchet mechanism for a ratchet tool includes a selection member pivotably connected to the tool and having two through holes in each of which a bead, a biasing piece and a spring are received. The spring is located between the bead and the biasing piece. The two beads are engaged with two positioning recesses defined in the slot in which the selection member is received. The two biasing pieces are engaged with a concavity defined in a side of the pawl which is matched with the engaging member. One of two ends of the pawl is pushed to match with the engaging member by pivoting the selection member.

### FIELD OF THE INVENTION

The present invention relates to a ratchet tool that has a selection member pivotably received in the tool and two biasing pieces are received in two through holes in the selection member for engaging with a concavity in the back of the pawl so as to control the engagement with the engaging member of the ratchet tool.

### BACKGROUND OF THE INVENTION

A conventional pawl control device for shifting the pawl to engage with the teeth of the engaging member in the ratchet tool is located in the tool and cannot be accessed. When the pawl is shifted to one direction, the ratchet tool may output a torque in one direction, vice versa. Generally, the pawl has a protrusion at a rear end thereof and the selection member has a shifting portion which pushes the protrusion and shifts the pawl. The user has to exert a large force to shift the pawl.

The present invention intends to provide a ratchet mechanism wherein two biasing pieces are connected to the selection member which is pivoted by pushing either one of two ends thereof to control which end of the pawl to match with the engaging member.

### SUMMARY OF THE INVENTION

In accordance with one aspect of the present invention, there is provided a ratchet mechanism for a ratchet tool which has a head with a hole defined therethrough so as to receive an engaging member therein. A recess is defined in an inner periphery of the hole so as to receive a pawl therein. A slot is defined in a side of the head and communicates with the recess. Two positioning recesses are defined in an inner periphery of the slot.

A selection member is pivotably inserted in the slot and has two through holes for respectively receiving a bead, a spring and a biasing piece. The two beads are engaged with the two positioning recesses and the biasing pieces are engaged with a concavity defined in a back of the pawl. The pawl is pivoted by pressing either one of two protruding ends of the selection member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the ratchet tool of the present invention;

FIG. 2 is a cross sectional view to show the ratchet tool of the present invention, wherein the left end of the selection member is pushed;

FIG. 3 is a cross sectional view to show the ratchet tool of the present invention, wherein the right end of the selection member is pushed;

FIG. 4 is a side cross sectional view to show the ratchet tool of the present invention, and

FIG. 5 is a perspective view to show the ratchet tool of the present invention.

### DETAILED DESCRIPTION OF THE PREFERRED EMBODIMENT

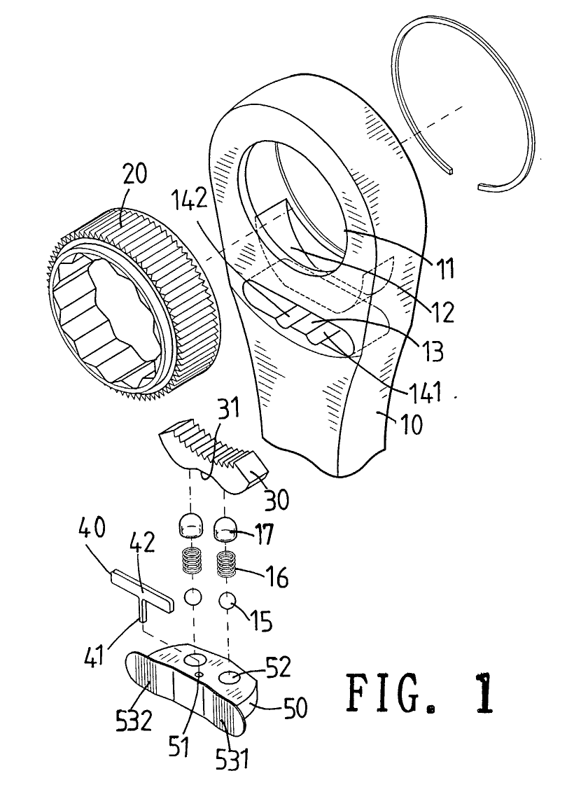

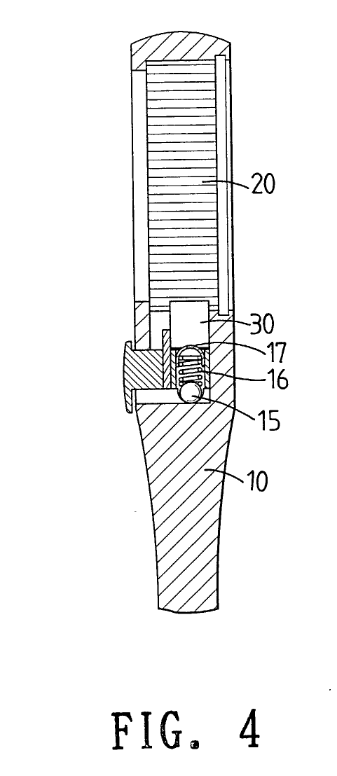

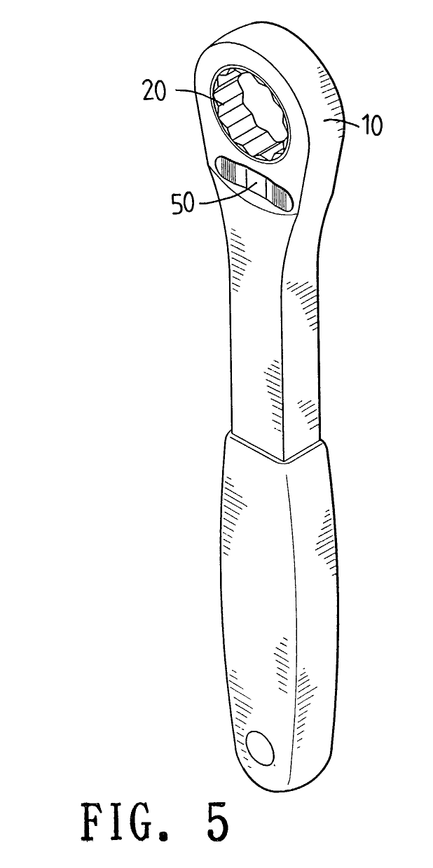

Referring to FIGS. 1, 2, 4 and 5, the ratchet tool of the present invention comprises a head 10 having a hole 11 defined therethrough and a shank extends from the head 10. An engaging member 20 with a toothed outer periphery is rotatably received in the hole 11. A recess 12 is defined in an inner periphery of the hole 11 and a pawl 30 is movably received therein. A slot 13 is defined in a side of the head 10 and communicates with the recess 12. Two positioning recesses 141, 142 are defined in an inner periphery of the slot 13.

The pawl 30 has a toothed surface defined in a first side of the pawl 30 and the toothed surface is matched with the toothed outer periphery of the engaging member 20. A concavity 31 is defined in a second side of the pawl 30 and in communication with the slot 13.

A selection member 50 includes a body for being inserted in the slot 13 and the body is pivoted received in the slot 13 by a retaining piece 40 which has an insertion 41 inserted in the hole 51 in the body. A top plate is connected to an end of the body and located on the side of the tool. The top plate includes two protruding ends 531, 532 and a sink portion is located between the two protruding ends 531, 532. Therefore, the user may push either of the two protruding ends 531, 532 to pivot the selection member 50.

Two through holes 52 are defined through the body of the selection member 50 and each through hole 52 has a bead 15, a spring 16 and a biasing piece 17 received therein. The bead 15 and the biasing piece 17 are respectively biased by two ends of the spring 16. The two beads 15 are engaged with the two positioning recesses 141, 142 to position the selection member 50. The two biasing pieces 17 are engaged with two inclined sides of the concavity 31 of the pawl 30. The retaining piece 40 has a bar 42 which contacts and retains the biasing pieces 17 from being disengaged from the through holes 52.

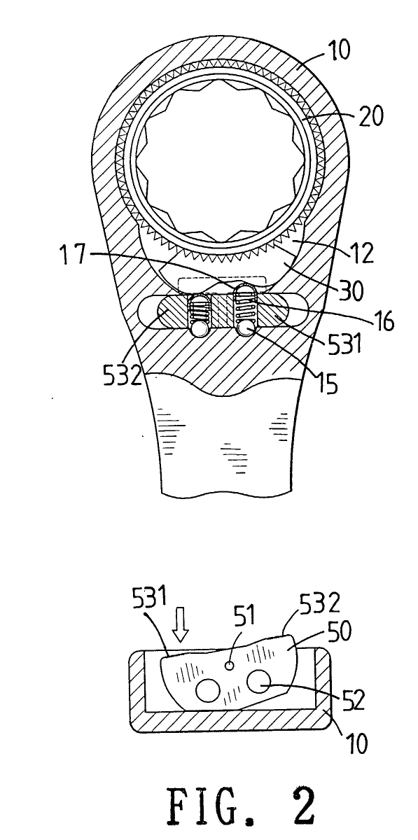

When pushing the left protruding end 532 of the selection member 50 as shown in FIG. 2, the biasing piece 17 on the right is raised in FIG. 2 and pushes the inclined side of the concavity 31 to let the right end of the pawl to contact against the inside of the recess 12. Therefore, the ratchet tool may tight or loosen an object when rotating counter clockwise.

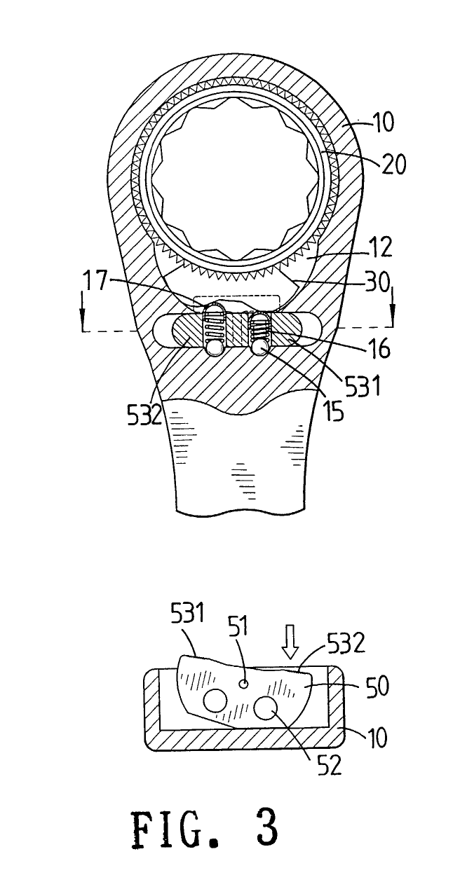

Referring to FIG. 3, the selection member 50 can also be pivoted by pushing the right protruding end 532 so that the left end of the pawl 30 contacts the inside of the recess 12 and the ratchet tool may tight or loosen an object when rotating clockwise.

While we have shown and described the embodiment in accordance with the present invention, it should be clear to those skilled in the art that further embodiments may be made without departing from the scope of the present invention.

What is claimed is:

1. A ratchet tool comprising:
a head having a hole defined therethrough and a recess defined in an inner periphery of the hole, a slot defined in a side of the head and communicating with the recess, two positioning recesses defined in an inner periphery of the slot;
an engaging member rotatably received in the hole of the head and having a toothed outer periphery;
a pawl movably received in the recess and having a toothed surface defined in a first side of the pawl, the toothed surface matched with the toothed outer periphery of the engaging member, a concavity defined in a second side of the pawl, and
a selection member pivotably inserted in the slot and two through holes defined through the selection member, a top plate connected to the selection member and having two protruding ends with a sink portion between the two protruding ends, a bead, a spring and a biasing piece received in each of the through holes, the bead and the biasing piece respectively biased by two ends of the spring, the two beads respectively engaged with the two positioning recesses in the slot and the two biasing pieces engaged with the concavity of the pawl.

2. The ratchet tool as claimed in claim 1, wherein the selection member has an elongated groove and a retaining piece is inserted in the elongated groove, the retaining piece having a bar which contacts and retains the biasing piece from being disengaged from the through hole.
